(19) United States
(12) Patent Application Publication
(10) Pub. No.: US 2026/0128636 A1
(43) Pub. Date: May 7, 2026

(54) GROUNDING BRUSH ASSEMBLY

(71) Applicant: AKTIEBOLAGET SKF, GOTEBORG (SE)

(72) Inventors: Thomas PERROTIN, Saint Roch (FR); Emmanuel BENEVISE, Monts (FR); Kevin WATTIEAUX, Pernay (FR); Bruno CONSTANT, Tours (FR); Jean-Marie GERARD, Joué-Lès-Tours (FR); Benoit ARNAULT, Saint-Cyr-sur-Loire (FR)

(21) Appl. No.: 19/371,074

(22) Filed: Oct. 28, 2025

(30) Foreign Application Priority Data
Nov. 7, 2024 (FR) FR2412168

(51) Int. Cl. H02K 5/14; H02K 5/16; H02K 7/00; H02K 7/08; H02K 11/40

(52) U.S. Cl. CPC H02K 5/14; H02K 5/16; H02K 7/003; H02K 7/08; H02K 11/40

(57) ABSTRACT

A grounding brush assembly includes a grounding brush and a mounting plate for the brush, the brush being provided with a plurality of conductive fibers and with a support inside of which the conductive fibers are housed. The mounting plate is secured to the support and is provided with a radially extending main body, retaining tongues for axially and radially holding the support, and with an axially extending centering portion. The mounting plate further includes at least one flange extending radially inwardly from a distal end of the axial portion.

### CROSS-REFERENCE

This application claims priority to French patent application no. 2412168 filed on Nov. 7, 2024, the contents of which are fully incorporated herein by reference.

### BACKGROUND OF THE INVENTION

The present invention relates to grounding devices for controlling the shaft current generated in electric motors or machines, and more particularly to grounding brush assemblies.

In an electric motor or machine, at least one rolling bearing is typically mounted between a housing of the electric motor or machine and a rotary shaft in order to rotatably support the shaft and couple the shaft with the housing.

During operation of the motor or machine, as the shaft rotates, a difference in electrical potential between the shaft and the housing of the electric motor or machine can be present, which may generate an electric current between an inner race of the rolling bearing, which is secured to the shaft, and an outer race of the bearing that is secured to the housing.

Any electric current passing through the components of the rolling bearing may damage these components, in particular the rolling elements and the raceways formed on the inner and outer races. Such electrical discharges can also generate vibration.

In order to remedy these drawbacks, it is a known practice to earth or ground the rotary shaft by using a grounding brush comprising conductive fibers. The grounding brush is generally mounted within the bore of the housing of the electric motor in such a way that the free ends of the fibers are in radial contact with the outer surface of the rotary shaft.

Due to the conductivity of the fibers, the brush is kept at the same electrical potential as the housing of the electric motor. The inner and outer races of the rolling bearing are also at the same electrical potential, which reduces or even eliminates problematic electrical discharges through the rolling bearing.

US Patent Publication No. 2021/0021180A1 discloses a grounding brush assembly comprising a grounding brush provided with a support and with a plurality of conductive fibers mounted within the support, and an annular mounting plate provided with a plurality of tongues for radially and axially retaining the grounding brush support and with an annular outer flange radially surrounding the brush and the tongues. The tongues are formed by plastic deformation of the mounting plate.

Such a grounding brush assembly is mounted in an electrical machine by force-fitting the assembly into the bore of the housing, which typically makes the grounding brush assembly difficult to remove.

The present invention aims to remedy this drawback.

### SUMMARY OF THE INVENTION

The present invention relates to a grounding brush assembly for an electric motor provided with a rotating shaft, with a fixed housing and with a bearing.

The assembly comprises a grounding brush provided with a plurality of conductive fibers and with a support inside which the conductive fibers are mounted. The assembly also comprises a brush mounting plate which is secured to the support of the brush.

The mounting plate comprises: a main body formed by a radial portion extending radially outwards with respect to the support; a plurality of centering tongues protruding axially with respect to the radial portion, each tongue locally radially surrounding the support of the brush and being in radial contact with the support, the support being held axially bearing against the radial portion of the mounting plate by the tongues; and a centering portion at least axially extending the main body, extending axially on the same side as the tongues, offset radially outwards with respect to the support and the tongues, and provided with an outer surface defining the outer diameter of the mounting plate in order to center the mounting plate after mounting in a bore of the housing of an associated electric motor.

According to a general feature of the present invention, the centering portion includes at least one flange extending radially inwardly from a distal end of the axial portion.

In one embodiment, the centering portion may be annular. Alternatively, the centering portion may comprise a plurality of axial portions spaced apart from one another in the circumferential direction.

In one embodiment, the flange is annular. Alternatively, the mounting plate may include a plurality of flanges spaced apart from one another in the circumferential direction, each flange extending radially inwardly from the distal end of an axial portion of the centering portion.

The present invention also relates to an electric machine or motor comprising a housing, a shaft, and a grounding brush assembly as defined above mounted at least partially radially between the housing and the shaft, the conductive fibers of the assembly being in contact with the shaft.

According to a preferred embodiment of the invention, the flange of the mounting plate of the assembly is housed radially within the bore of the housing. The centering portion extends in an axial direction inside the bore, but does not extend beyond its end.

### BRIEF DESCRIPTION OF THE SEVERAL VIEWS OF THE DRAWINGS

The present invention will be better understood on studying the detailed description of embodiments, given by way of non-limiting example and illustrated by the appended drawings, in which:

FIG. 1 is a view in axial section of a grounding brush assembly mounted at least partially radially between a rotary shaft and a housing of an electric motor according to one exemplary embodiment of the invention;

FIG. 2 is a perspective view of the grounding brush assembly in FIG. 1;

FIG. 3 is a front view of the grounding brush assembly in FIG. 1;

FIG. 4 is a view in section of the assembly in FIG. 3 along line I-I;

FIG. 5 is a view in section of the assembly in FIG. 3 along line II-II; and

FIG. 6 is a front view of an alternative construction of the grounding brush assembly.

### DETAILED DESCRIPTION OF THE INVENTION

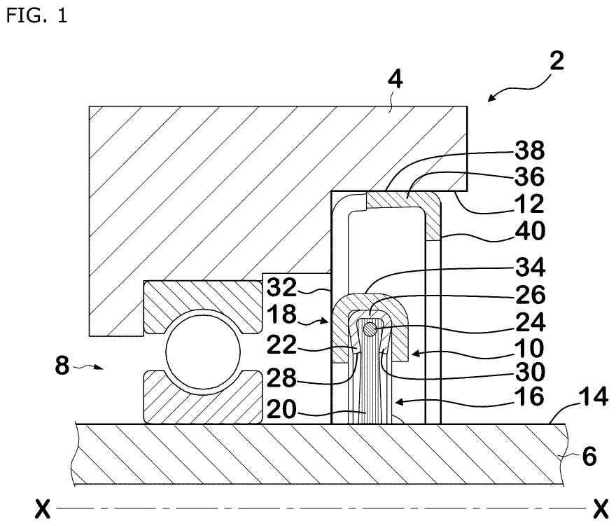

FIG. 1 shows, in axial section, part of an electric motor or machine 2 comprising a fixed housing 4, a rotary shaft 6 which is rotatable about a central axis X-X, and a bearing 8 radially supporting the shaft 6 and rotatably coupling the shaft 6 with the housing 4. The bearing 8 is preferably a ball bearing as depicted in FIG. 1, but may be any other type of rolling element bearing, such as a cylindrical roller bearing, a tapered roller bearing, a needle roller bearing, etc., and may even be formed as a plain bearing.

The motor 2 comprises a grounding brush assembly 10 which is mounted at least partially radially between the bore 12 of the housing and the outer cylindrical surface 14 of the shaft. The assembly 10 is, for example, force-fit into the bore 12 of the housing 4.

In the remainder of the description, the adjectives “axial” and “radial” and the adverbs “axially” and “radially” are defined with respect to the central axis X. Thus, an axial portion or part is parallel to the axis X, whereas a radial part or portion is perpendicular to this axis and surrounds it. In addition, a radial portion is provided with an “inner” surface oriented towards the axis X, and with an “outer”surface oriented away from this axis.

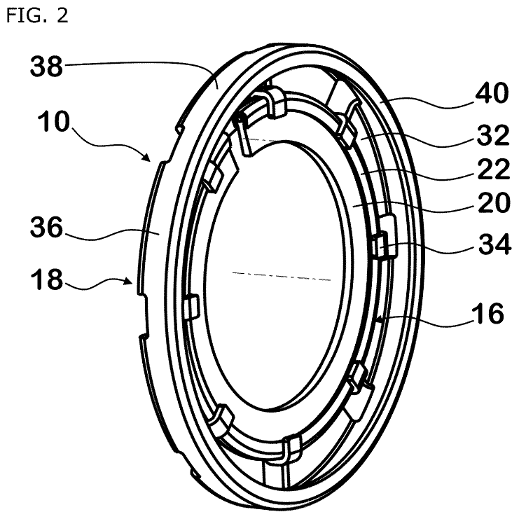

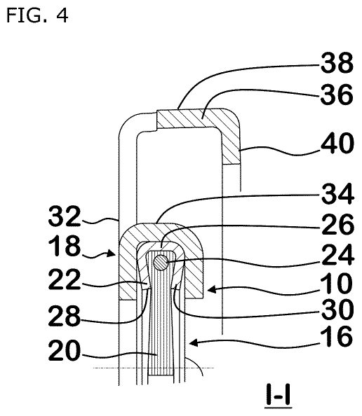

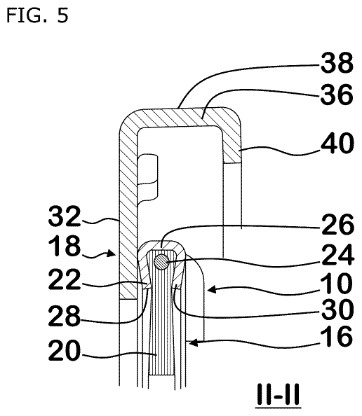

As best shown in FIGS. 2-5, the grounding brush assembly 10 has a generally annular shape. The assembly 10 basically comprises a grounding brush 16 and a mounting plate 18 for the brush 16.

The grounding brush 16 includes an annular support 22 and a plurality of conductive fibers 20 housed inside or disposed within the support 22. The conductive fibers 20 may be, for example, formed of carbon, stainless steel, conductive plastics, such as acrylic fibers or fibers made of nylon, etc. The plurality of conductive fibers 20 are arranged within the support 22 so as to form of an open ring. As shown in FIGS. 1, 4 and 5, the conductive fibers 20 are preferably bent around a connecting wire 24. The distal free end of each of the conductive fibers 20 is intended to come into radial contact with the outer surface 14 of the shaft 6.

In order to ensure the mounting and the retention of the conductive fibers 20 within the support 22, the support 22 preferably includes a cylindrical portion 26, a first lateral edge 28 extending radially inwardly from one axial end of the cylindrical portion 26 and a second lateral edge 30 extending radially inwardly from an opposing axial end of the cylindrical portion 26. The first edge 28 is positioned axially toward the outside of the assembly 10, whereas the second edge 30 is positioned axially toward the bearing 8, as shown in FIG. 1, the edges 28, 30 being axially opposite with respect to the cylindrical portion 26 and the fibers 20.

The mounting plate 18 is secured to the support 22 of the grounding brush 16. The mounting plate 18 includes a main body 32 formed by a radial portion, which is in axial abutment against the first edge 28 of the support 22, a plurality of tongues 34 for axially and radially retaining the brush 16, and an axial centering portion 36.

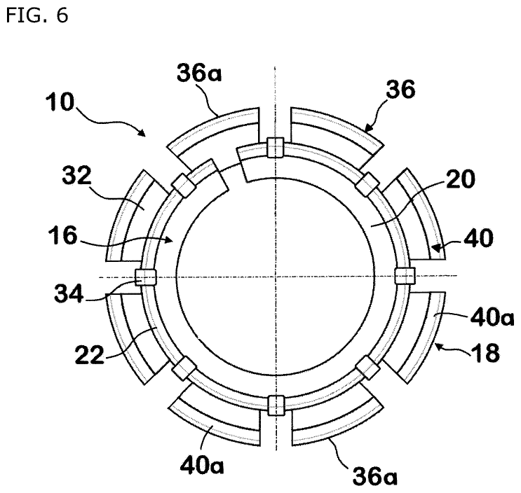

The centering portion 36 of the mounting plate 18 extends axially from the main body 32, in a direction away from the bearing 8. According to the embodiment illustrated in FIGS. 1 to 5, the centering portion 36 consists of, or is formed as, an annular cylindrical portion. Alternatively, the centering portion 36 comprises a plurality of axial portions 36a spaced apart from one another in the circumferential direction; i.e., circumferentially spaced apart about the geometric center (not indicated) of the mounting plate 18, as shown in FIG. 6.

The centering portion 36 is provided with an outer surface 38 defining the outer diameter of the mounting plate 18 in order to center the mounting plate 18 after mounting it within the bore 12 of the housing 4 of the associated electric motor 2. The centering portion 36 is preferably force-fit into the bore 12 of the housing 4 in order to create a diametrical interference for ensuring the mechanical retention of the mounting plate 18 within the housing 4.

The retaining tongues 34 extend from the main body 32 of the mounting plate 18 and are spaced apart from one another in the circumferential direction. The tongues 34 protrude axially from the main body 32 in a direction away from the bearing 8.

Each retaining tongue 34 extends from the main body 32 of the mounting plate 18 such that the retaining tongue 34 locally radially surrounds and radially contacts the support 22 of the brush 16. The support 22 is held axially by the tongues 34 so as to retain the support 22 connected with the mounting plate 18. Furthermore, the tongues 34 are each provided with a bent edge (not indicated) disposed on the support 22 in order to create an axial contact. The support 22 is held axially bearing against, i.e., disposed against, the radial portion 32 of the mounting plate 18 by the tongues 34. The support 22 is thus held axially and radially by the retaining tongues 34.

In the illustrated example, the mounting plate 18 preferably includes eight retaining tongues 34 spaced apart regularly or evenly in the circumferential direction. As a variant, the mounting plate 18 includes any other appropriate or desired number of retaining tongues 34. If the mounting plate 18 includes a plurality of centering portions 36a, the positions of the tongues 34 may alternate circumferentially with the centering portions 36a, as shown in FIG. 6.

The centering portion 36 extends axially from the main body 32, preferably from the same axial side as the support 22 and the tongues 34, and is offset radially outwardly with respect to both the support 22 and the tongues 34.

The cylindrical portion 26 of the support 22 is in radial contact against the retaining tongues 34 and the second lateral edge 30 is in axial contact against the tongues 34. The cylindrical portion 26 extends from the large-diameter border of the first lateral edge 28. Preferably, the cylindrical portion 26 extends axially as depicted, but may alternatively extend both axially and obliquely.

The second lateral edge 30 of the support 22 extends radially inwardly from the cylindrical portion 26. Specifically, the second lateral edge 30 extends from the cylindrical portion 26 on the opposite side of the cylindrical portion 26 from the first lateral edge 28. The cylindrical portion 26 and the first and second lateral edges 28, 30 are each of annular shape and delimit a channel (not indicated) which is radially open on the inside and inside of which one end of the conductive fibers 20 is positioned or disposed. The first and second lateral edges 28, 30 axially clamp the conductive fibers 20. The conductive fibers 20 are in axial abutment on each side against the first and second lateral edges 28, 30.

In the illustrated exemplary embodiments, the conductive fibers 20 come into radial abutment against the cylindrical portion 26, the first and second lateral edges 28, 30 extending obliquely inwardly from the cylindrical portion 26 so as to clamp against the fibers 20. As a variant, the first and second lateral edges 28, 30 could extend entirely radially.

In the depicted embodiments, the mounting plate 18 and the support 22 are two separate pieces. As a variant, the mounting plate 18 could be produced as a single piece with the support 22, i.e., the plate 18 and support 22 are integrally formed, for example produced by cutting and pressing or stamping. In this case, the main body 32 of the mounting plate 18 extends from the small-diameter border of the first lateral edge 28.

The mounting plate 18 and the support 12 of the grounding brush 16 are preferably formed of an electrically conductive material, such as aluminum, stainless steel, bronze, copper, a conductive polymer of any other appropriate material.

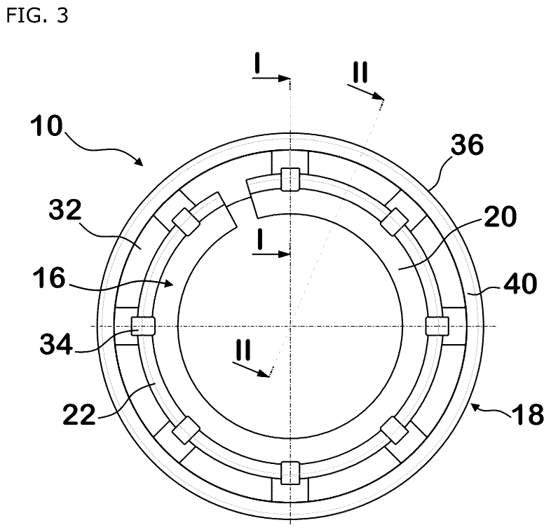

According to the present invention, the mounting plate 18 further includes an annular flange 40 extending radially inwardly from the distal end (i.e., distal from the remainder of the plate 18) of the axial and annular centering portion 36 of the mounting plate 18. Preferably, the flange 40 is annular and extends circumferentially around the entire perimeter of the mounting plate 18, as best shown in FIGS. 2 and 3. Alternatively, flange 40 may include a plurality of flanges or flange sections 40a spaced circumferentially apart from each other, as shown in FIG. 6.

In the example shown, the flange 40 has a connection portion for connecting to the curved centering portion 36, and a radially extending portion extending radially inwardly from the connection portion. As a variant, the flange 40 could extend entirely radially.

Referring once again to FIG. 1, the assembly 10 is mounted radially in part between the bore 12 of the housing 4 and the outer cylindrical surface 14 of the shaft 6 such that the radial portion 32 of the mounting plate 18 preferably bears axially against a shoulder of the housing 4. The centering portion 36 of the mounting plate 18 bears radially outwardly against the bore 12 of the housing 4.

By virtue of the present invention, the grounding brush assembly 10 can be mounted in a simple manner and without risk of deformation in a housing 4 and on a rotating shaft 6.

In fact, prior art grounding brush assemblies, such as for example as disclosed in US Patent Publication No. 2021/0021180 A1, is force-fit into the bore of a housing by a mounting tool in axial abutment against the edges of the tongues, which exerts a force in the axial direction of insertion. Such a mounting method entails a suitable design of the grounding brush assembly, in particular a sufficient radial dimension of the tongues and of the support in order to withstand the force exerted.

With the present invention, the grounding brush assembly 10 is force-fit within the bore 12 of the housing 4 by a mounting tool (not shown) that axial abuts against the lateral face of the flange 40 and exerts a force in the axial direction of insertion. Consequently, the tongues 34 no longer have the function of supporting the tool, and can be suitably dimensioned solely for their function of retaining the support 22. As such, the tongues 34 and the support 22 can be reduced in dimension as compared to prior art assemblies, and allow the entire assembly 10 to be formed more radially compact. The flange 40 is dimensioned in a suitable manner for the function of supporting the mounting tool, without affecting the radial compactness of the assembly 10.

As a result, the tongues 34 and the support 22 are no longer subjected to direct force exerted by a mounting tool, which thus eliminates the risk of these parts deforming during the insertion of the assembly 10 in a housing 4.

According to the illustrated embodiment, the annular flange 40 of the mounting plate 18 of the assembly 10 is housed radially within the bore 12 of the housing 4. The centering portion 36 extends in an axial direction inside the bore 12, but does not extend beyond its end. The assembly 10 thus retains an optimized axial compactness. According to a variant that is not shown, and depending on the possible needs, the centering portion 36 may extend axially beyond the bore 12, in which case the flange 40 would be disposed outside of the bore 12.

As the flange 40 extends radially inwardly, the flange 40 enables the use of a removal tool (not shown) to remove the assembly 10 from the housing 4. Such a tool may be designed to enter a space defined between the radial portion 32 of the plate 18 and the flange 40, in order to come into axial abutment against an inner lateral surface of the flange 40. The removal tool can then exert an axial force in a direction opposite to the direction of insertion, on the opposite side from the housing 4. The assembly 10 can thus be mounted and then removed easily. A maintenance operation can be carried out easily to replace an assembly 10 according to the invention.

Lastly, the flange 40 increases the rigidity of the centering portion 36, which is forcibly mounted within the housing 4. The risks of the portion 36 deforming during the fitting or the removal of the assembly 10 end up being reduced.

Furthermore, all or only some of the technical features of the various embodiments may be combined with one another. Thus, the grounding brush assembly can be adapted in terms of cost, performance and ease of use.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly for an electric motor, the motor including a shaft rotating about an axis, a fixed housing with a bore, and a bearing coupling the shaft with the bore, the grounding brush assembly including:
a grounding brush including a support and a plurality of conductive fibers disposed at least partially within the support; and
a brush mounting plate secured to the support of the brush and including a main body formed by a radial portion extending radially outwardly with respect to the support of the grounding brush, a plurality of centering tongues protruding axially from one side of the main body, each tongue locally radially surrounding and in radial contact with the support of the brush so as to hold the support axially against the main body of the mounting plate, a centering portion extending at least axially from the one side of the main body, having a distal end spaced axially from the main body and being offset radially outwardly with respect to the support of the brush and the centering tongues, the centering portion having an outer surface defining an outer diameter of the mounting plate and being configured to center the mounting plate within the bore of the housing of the electric motor, and at least one flange extending radially inwardly from the distal end of the centering portion.

2. The assembly according to claim 1, wherein the centering portion is annular.

3. The assembly according to claim 1, wherein the centering portion includes a plurality of axial portions spaced circumferentially apart from each other.

4. The assembly according to claim 1, wherein the flange is annular.

5. The assembly according to claim 1, wherein the at least one flange includes a plurality of flange sections spaced circumferentially apart from each other.

6. An electric motor comprising:
a housing;
a shaft; and
a grounding brush assembly according to claim 1 mounted at least partially radially between the housing and the shaft, the conductive fibers of the assembly being in contact with the shaft.

7. The motor according to claim 6, wherein the flange of the mounting plate of the grounding brush assembly is housed radially within the bore of the housing.
